(19) United States
(12) Patent Application Publication
(10) Pub. No.: US 2026/0260826 A1
(43) Pub. Date: Sep. 3, 2026

(54) Balance Frame Trigger Photoelectric Conduction Mechanism Applied to Key Switch

(71) Applicant: DONGGUAN CITY KAIHUA ELECTRONICS CO.LTD, Dongguan, Guangdong (CN)

(72) Inventors: Fuxi WU, Dongguan, Guangdong (CN); Panhao LV, Dongguan, Guangdong (CN)

(21) Appl. No.: 18/995,808

(22) PCT Filed: Dec. 4, 2023
(86) PCT No.: PCT/CN2023/136105

§ 371 Date: Jan. 16, 2025

(30) Foreign Application Priority Data
Dec. 13, 2022 (CN) 202223338092.3

(51) Int. Cl. H01H 13/02; H01H 13/52

(52) U.S. Cl. CPC H01H 13/023; H01H 13/52

(57) ABSTRACT

A balance frame trigger type photoelectric conduction mechanism used in a button switch, comprising a base (1), a balance frame assembly (2) disposed on the base (1), and a light-emitting pair tube (3) electrically connected to a PCB (4). The balance frame assembly (2) comprises two balance frames (21) rotatably connected to the base (1) separately, and an elastic member (22) connected between the two balance frames (21). The balance frames of the balance frame assembly have a function of triggering on/off of a button switch, so that a smooth pressing action is synchronized with an optical path on/off action, thereby implementing synchronization between smooth pressing and an on/off action of the button switch, and improving the accuracy and sensitivity of the on/off action of the button switch; moreover, the service life is long.

### TECHNICAL FIELD

The utility model relates to the field of key switches, in particular to a balance frame trigger photoelectric conduction mechanism applied to key switches.

### TECHNICAL BACKGROUND

In the existing key switch, in order to improve the pressing balance, a balance frame structure is usually added inside the key switch, so that when the key cap on the key switch is pressed at any position, it can move down smoothly, thus improving the pressing balance.

However, the existing balance frame structure only plays the role of balance pressing and has a single function.

At the same time, due to the limitation of internal conduction structure design, the accuracy and sensitivity of conduction and disconnection actions are low.

### SUMMARY OF UTILITY MODEL

In view of the above shortcomings, the utility model aims to provide a balance frame trigger photoelectric conduction mechanism applied to key switches, which endows the balance frame of the balance frame assembly with the function of triggering the key switch to make the smooth pressing action and the light path on-off action synchronous, thus realizing the synchronization of the smooth pressing and the key switch on-off action, improving the accuracy and sensitivity of the key switch on-off action, and having long service life.

The technical scheme adopted by the utility model is as follows:

The invention relates to a balance frame trigger photoelectric conduction mechanism applied to a key switch, which comprises a base, a balance frame component arranged on the base, and a light emitting diode electrically connected to a PCB. Wherein, the balance frame assembly comprises two balance frames which are respectively rotatably connected to the base, and an elastic piece which is connected between the two balance frames, and the light-emitting pair tube comprises a light-emitting element and a photosensitive element which are respectively electrically connected to a PCB board, and is characterized in that one of the two balance frames is provided with a light shielding sheet for shielding light between the light-emitting element and the photosensitive element.

As a further improvement of the utility model, the shading sheet is arranged on the inner side of one of the two balancing frames, and the shading sheet extends towards the other balancing frame.

As a further improvement of the utility model, an accommodating cavity is formed on the lower end face of the base, and the light emitting element and the photosensitive element are embedded in the accommodating cavity; An opening is formed on the base, which is communicated with the accommodating cavity and used for longitudinally and movably inserting the shading sheet.

As a further improvement of the utility model, the shading sheet is arranged on the outer side of one of the two balancing frames, and the shading sheet extends away from the other balancing frame.

As a further improvement of the utility model, the light-emitting element and the light-sensitive element are arranged at the outer side of the balance frame with the shading sheet, and are located directly below the shading sheet.

As a further improvement of the utility model, the elastic piece is a tension spring; A connecting hole is respectively formed on the two balance frames, and one end of the tension spring is connected to the connecting hole of one of the two balance frames, and the other end is connected to the connecting hole of the other balance frame.

The utility model has the beneficial effects that: By arranging the shading sheet on the inner side or the outer side of one of the balance frames of the balance frame assembly and synchronously adjusting the position where the light-emitting pair tube is arranged, the light path between the light-emitting element and the photosensitive element can be connected or blocked by the shading sheet, which endows the balance frame of the balance frame assembly with the function of triggering the on-off of the key switch, so that the smooth pressing action is synchronized with the on-off action of the light path, thereby realizing the synchronization of the smooth pressing and the on-off action of the key switch, improving the accuracy and sensitivity of the on-off action of the key switch, and having long service life.

The above is an overview of the technical scheme of the utility model, and the following is a further explanation of the utility model with the attached drawings and specific embodiments.

### BRIEF DESCRIPTION OF DRAWINGS

FIG. 1 is an explosion diagram of embodiment 1;

FIG. 2 is a structural diagram of embodiment 1;

FIG. 3 is a sectional view of embodiment 1;

FIG. 4 is a schematic structural diagram of the base in Embodiment 1;

FIG. 5 is a schematic structural view of the light-emitting pair tube arranged at the bottom of the base in embodiment 1;

FIG. 6 is a schematic structural diagram of embodiment 2.

### EMBODIMENT

In order to further explain the technical means and effects adopted by the utility model to achieve the predetermined purpose, the specific implementation of the utility model will be described in detail with the attached drawings and preferred embodiments.

### Embodiment 1

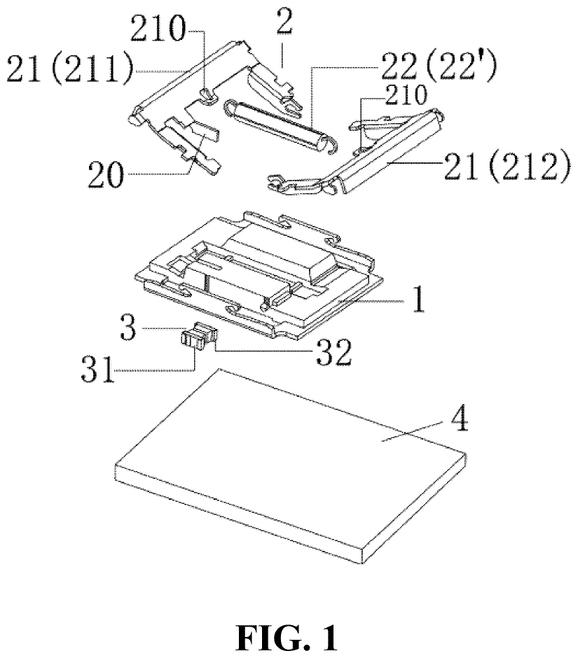

Please refer to FIG. 1 to FIG. 3. This embodiment provides a balance frame triggered photoelectric conduction mechanism applied to a key switch, which comprises a base 1, a balance frame component 2 arranged on the base 1, and a light emitting diode 3 electrically connected to a PCB board 4. The balance frame assembly 2 includes two balance frames 21 rotatably connected to the base 1, and an elastic member 22 connected between the two balance frames 21. The light-emitting pair tube 3 includes a light-emitting element 31 and a light-sensitive element 32 electrically connected to the PCB board 4, and one of the two balance frames 21 is provided with a light shielding sheet 20 for shielding light between the light-emitting element 31 and the light-sensitive element 32.

When the balance frame assembly 2 is forced to move up and down, the balance frame assembly 2 provides balance and stability for the pressing of the key switch, and at the same time, it drives the light shielding plate 20 to move up and down synchronously, thereby shielding and removing the light between the light-emitting element 31 and the photosensitive element 32, that is, connecting or blocking the light path between the light-emitting element 31 and the photosensitive element 32, so as to trigger the light-emitting tube 3 to be turned on and off, thereby realizing the on and off functions of the key switch. By arranging the shading sheet 20 on the balance frame 21 of the balance frame assembly 2, the balance frame assembly 2 is endowed with the function of triggering the on-off of the key switch, so that the smooth pressing action is synchronized with the on-off action of the optical path, thereby realizing the synchronization of the smooth pressing and the on-off action of the key switch, improving the accuracy and sensitivity of the on-off action of the key switch, and having long service life.

Specifically, when the two balance frames 21 are under pressure, the shading sheet 20 moves downwards, and at the same time, the elastic member 22 is elastically deformed, so that the shading sheet 20 moves downwards into the optical path between the light-emitting element 31 and the photosensitive element 32, shielding the light between the light-emitting element 31 and the photosensitive element 32, and setting this state as a key switch on state; When the pressure on the two balance frames 21 disappears, the two balance frames 21 are driven to swing up by the elastic restoring force of the elastic piece 22, and then the light shielding sheet 20 moves up and leaves the optical path between the light emitting element 31 and the photosensitive element 32, so that the light shielding between the light emitting element 31 and the photosensitive element 32 is eliminated, and this state is set as the key switch off state.

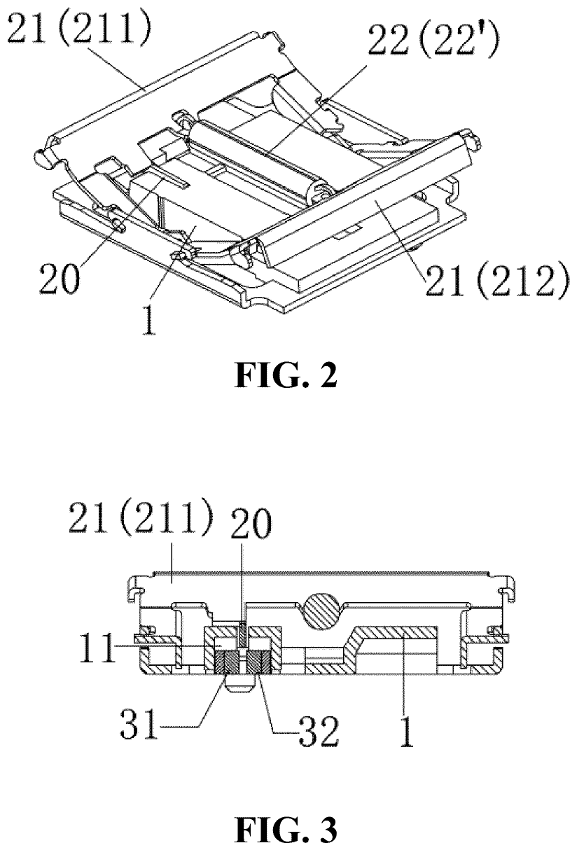

In this embodiment, as shown in FIGS. 1 and 2, the shading sheet 20 is arranged on the inner side of one of the two balancing frames 21, and the shading sheet 20 extends towards the other balancing frame. When the two balance frames 21 swing up and down under pressure, the light shielding plate 20 arranged on the inner side can be driven to move up and down synchronously, so that the light path between the light emitting element 31 and the photosensitive element 32 can be connected or blocked.

As for the installation of the light-emitting element 31 and the light-sensitive element 32, as shown in FIGS. 3 and 5, an accommodating cavity 11 is formed on the lower end face of the base 1 in this embodiment, and the light-emitting element 31 and the light-sensitive element 32 are embedded in the accommodating cavity 11;

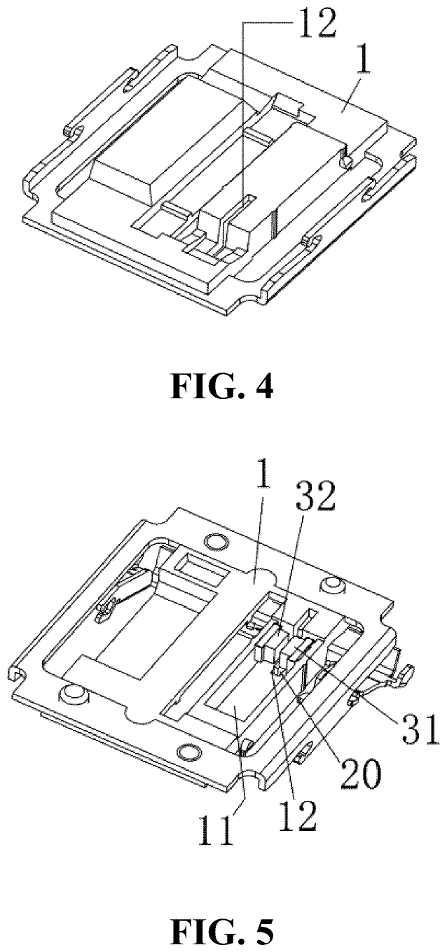

An opening 12 is formed on the base 1, which communicates with the accommodating cavity 11 and is used for the longitudinal movable insertion of the shading sheet 20, so as to give way, as shown in FIG. 4. When the shading sheet 20 moves up and down with the two balance frames 21, the shading sheet 20 is inserted into the opening 12, enters the accommodating cavity 11, and moves up and down in the optical path formed between the light-emitting element 31 and the photosensitive element 32, so as to connect or block the optical path between the light-emitting element 31 and the photosensitive element 32.

In this embodiment, as shown in FIG. 1, the elastic member 22 is a tension spring 22′; A connecting hole 210 is respectively formed in the two balance frames 21, and one end of the tension spring 22′ is connected to the connecting hole 210 of one of the two balance frames 21, and the other end is connected to the connecting hole 210 of the other balance frame. Therefore, when the two balance frames 21 swing up and down under pressure to provide balance and stability, the tension spring 22′ can be driven to move up and down synchronously, and the tension spring 22′ provides elastic restoring force for pressing and resetting.

In this embodiment, the two balance frames 21 can be named as the first balance frame 211 and the second balance frame 212 respectively, and specifically, the shading sheet 20 can be arranged on the inner side of the first balance frame 211. When in use, a key cap is installed on the first balance frame 211 and the second balance frame 212. The specific structure of the first balance frame 211 and the second balance frame 212, and the installation mode of the key cap are not the innovation points of this utility model. For the specific structure, please refer to the utility model patent with the patent number of 202121092814.4 and the patent name is “a photoelectric key switch for increasing the pressing feel”, which will not be repeated here.

### Embodiment 2

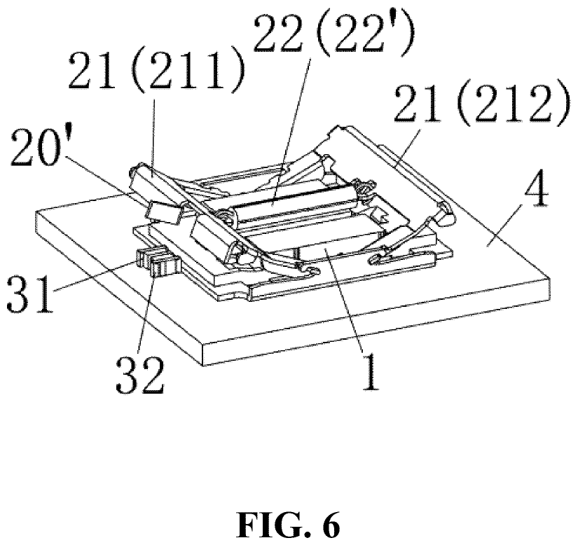

The main differences between this embodiment and Embodiment 1 are as follows: As shown in FIG. 6, the shading sheet 20′ is arranged on the outer side of one of the two balancing frames 21, and the shading sheet 20′ extends away from the other balancing frame. Specifically, the two balance frames 21 can be named as the first balance frame 211 and the second balance frame 212, and the shading sheet 20′ can be arranged on the outer side of the first balance frame 211.

Meanwhile, the light-emitting element 31 and the photosensitive element 32 are arranged outside the balance frame 21 with the light-shielding sheet 20′, and are located directly below the light-shielding sheet 20′.

When the two balance frames 21 swing up and down under pressure, the shading sheet 20′ arranged on the outer side can be driven to move up and down synchronously, so that the light path between the light-emitting element 31 and the photosensitive element 32 can be connected or blocked, and the light-emitting pair tube 3 can be triggered to be connected and disconnected, so that the key switch can be connected and disconnected.

What needs to be explained here is that the balance frame triggered photoelectric conduction mechanism disclosed by this utility model is an improvement on the specific structure, but it is not an innovation of this utility model for the specific control mode.

The PCB board, light-emitting element, photosensitive element and other parts involved in this utility model can be common standard parts or parts known to technicians in this field, and their structures, principles and control methods are known to technicians in this field through technical manuals or through conventional experimental methods.

The above is only the preferred embodiment of this utility model, and it does not limit the technical scope of this utility model. Therefore, other structures obtained by adopting the same or similar technical features as the above embodiments of this utility model are within the protection scope of this utility model.

What is claimed is:

1. The invention relates to a balance frame trigger photoelectric conduction mechanism applied to a key switch, which comprises a base, a balance frame component arranged on the base, and a light emitting diode electrically connected to a PCB. Wherein, the balance frame assembly comprises two balance frames which are respectively rotatably connected to the base, and an elastic piece which is connected between the two balance frames, and the light-emitting pair tube comprises a light-emitting element and a photosensitive element which are respectively electrically connected to a PCB board, and is characterized in that one of the two balance frames is provided with a light shielding sheet for shielding light between the light-emitting element and the photosensitive element.

2. According to claim 1, the balance frame trigger photoelectric conduction mechanism applied to the key switch is characterized in that the shading sheet is arranged on the inner side of one of the two balance frames and extends towards the other balance frame.

3. According to claim 2, the balance frame triggered photoelectric conduction mechanism applied to the key switch is characterized in that an accommodating cavity is formed on the lower end face of the base, and the light emitting element and the photosensitive element are embedded in the accommodating cavity; An opening is formed on the base, which is communicated with the accommodating cavity and used for longitudinally and movably inserting the shading sheet.

4. According to claim 1, the balance frame trigger photoelectric conduction mechanism applied to the key switch is characterized in that the shading sheet is arranged on the outer side of one of the two balance frames and extends away from the other balance frame.

5. According to claim 4, the balance frame triggered photoelectric conduction mechanism applied to the key switch is characterized in that the light-emitting element and the light-sensitive element are arranged outside the balance frame with a light-shielding sheet and directly below the light-shielding sheet.

6. According to claim 1, the balance frame triggered photoelectric conduction mechanism applied to key switches is characterized in that the elastic piece is a tension spring; A connecting hole is respectively formed on the two balance frames, and one end of the tension spring is connected to the connecting hole of one of the two balance frames, and the other end is connected to the connecting hole of the other balance frame.
